(19) United States
(12) Patent Application Publication
(10) Pub. No.: US 2025/0356241 A1
(43) Pub. Date: Nov. 20, 2025

(54) CONTROL PULSE DISTORTION COMPENSATION USING REFLECTION PARAMETERS FROM ERROR AMPLIFICATION PULSE SEQUENCES

(71) Applicant: Google LLC, Mountain View, CA (US)

(72) Inventors: Benjamin Thomas Chiaro, Goleta, CA (US); Yaxing Zhang, Santa Barbara, CA (US); Kenneth William Lee, Santa Barbara, CA (US); Alexander Korotkov, Camarillo, CA (US)

(21) Appl. No.: 18/792,069

(22) Filed: Aug. 1, 2024

Related U.S. Application Data
(60) Provisional application No. 63/560,314, filed on Mar. 1, 2024.

(51) Int. Cl. G06N 10/70; G06N 10/40; G06N 10/60

(52) U.S. Cl. CPC G06N 10/70; G06N 10/40; G06N 10/60

(57) ABSTRACT

Methods, systems, and apparatus for microwave pulse distortion compensation using reflection parameters from error amplification pulse sequences. In one aspect, a method includes generating a pre-distorted control signal that implements a single qubit rotation operation and applying the pre-distorted control signal to a qubit to perform the rotation operation on the qubit. The pre-distorted control signal comprises an inverted transfer function, where the inverted transfer function comprises values of parameters obtained through fitting measured qubit parasitic rotation angles per gate to a reflection model that models pulse distortion in the quantum computing device; and the qubit parasitic rotation angles per gate are measured using a first pulse sequence that amplifies out-of-phase pulse distortion in the quantum computing device and a second pulse sequence that amplifies in-phase pulse distortion in the quantum computing device.

### CROSS-REFERENCE TO RELATED APPLICATION

This application claims the benefit under 35 U.S.C. § 119 (e) of U.S. Patent Application No. 63/560,314, filed on Mar. 1, 2024. The disclosure of the foregoing application is incorporated herein by reference in its entirety for all purposes.

### BACKGROUND

This specification relates to quantum computing.

Classical computers have memories made up of bits, where each bit can represent either a zero or a one. Quantum computers maintain sequences of quantum bits, called qubits, where each quantum bit can represent a zero, one or any quantum superposition of zeros and ones. Quantum computers operate by setting qubits in an initial state and manipulating the state of the qubits, e.g., according to a sequence of quantum logic gates. A calculation ends with qubit state readout, collapsing the state of the system of qubits into an eigenstate where each qubit represents either a zero or one. The ability to precisely control the state of a collection of quantum bits is a fundamental requirement of a quantum computer.

### SUMMARY

This specification describes technologies for microwave pulse distortion compensation using reflection parameters from error amplification pulse sequences.

In general, one innovative aspect of the subject matter described in this specification can be implemented in a method performed by a quantum computing device, the method comprising: measuring first qubit parasitic rotation angles per gate through consecutive applications of a first pulse sequence to the qubit, wherein the first pulse sequence comprises: a π pulse about an x axis followed by a −π pulse about the x axis and each first qubit parasitic rotation angle per gate corresponds to a respective inter-pulse delay; measuring second qubit parasitic rotation angles per gate through consecutive applications of a second pulse sequence to the qubit, wherein the second pulse sequence comprises: a π pulse about the x axis, followed by a π pulse about the y axis, followed by a π pulse about the x axis, followed by a π pulse about the y axis and each first qubit parasitic rotation angle per gate corresponds to a respective inter-pulse delay; determining values of parameters of a reflection model to fit the first qubit parasitic rotation angles per gate and the second qubit parasitic rotation angles per gate to the reflection model, wherein the reflection model models pulse distortion in the quantum computing device, comprising determining values of parameters of the reflection model; inverting a transfer function at the determined values of the parameters of the reflection model, wherein the transfer function corresponds to the reflection model; and pre-distorting one or more control pulses for the qubit using the inverted transfer function.

Other implementations of these aspects include corresponding computer systems, apparatus, and computer programs recorded on one or more computer storage devices, each configured to perform the actions of the methods. A system of one or more classical and quantum computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations the first pulse sequence amplifies out-of-phase pulse distortion in the quantum computing device and the second pulse sequence amplifies in-phase pulse distortion in the quantum computing device.

In some implementations pre-distorting the one or more control pulses for the qubit using the inverted transfer function comprises generating pre-distorted control pulses that, when applied to the qubit, reduce out-of-phase and in-phase pulse distortion.

In some implementations the parameters of the reflection model comprise reflection amplitude, round-trip reflection time, and phase shift imparted by reflection.

In some implementations the reflection model comprises a combination of an ideal control signal and a reflection component that comprises delayed control signals, wherein the delayed control signals are dependent on a round-trip reflection time parameter and are weighted by respective reflection amplitudes and reflection phase shifts.

In some implementations the reflection model X(t) is given by

$$X ( t ) \to X ( t ) + {\sum }_{k = 1}^{∞} {a}_{reflect}^{k} {e}^{i k {ϕ}_{reflect}} X ( t - k {t}_{reflect} )$$

where t represents time, X(t) represents an ideal control signal, a_{reflect} represents a reflection amplitude, and ϕ_{reflect} represents a phase shift imparted by reflection.

In some implementations determining values of parameters of the reflection model comprises numerically optimizing the values of parameters of the reflection model using the first qubit parasitic rotation angle per gate and the second qubit parasitic rotation angle per gate.

In some implementations measuring the first qubit parasitic rotation angles per gate through consecutive applications of the first pulse sequence to the qubit comprises applying the first pulse sequence to the qubit at each of multiple different gate depths and each of multiple different inter-pulse delays; and measuring the second qubit parasitic rotation angles per gate through consecutive applications of the second pulse sequence to the qubit comprises applying the second pulse sequence to the qubit at each of the multiple different gate depths and each of the multiple different inter-pulse delays.

In some implementations measuring the first qubit parasitic rotation angles per gate comprises measuring expectation values of one or more Pauli operators following the consecutive applications of the first pulse sequence to the qubit; and measuring the second qubit parasitic rotation angles per gate comprises measuring expectation values of the one or more Pauli operators following the consecutive applications of the second pulse sequence to the qubit.

In some implementations the method further comprises applying the pre-distorted control pulses to the qubit during a quantum computation.

In some implementations the one or more control pulses comprise control pulses that implement rotations about the x axis, y axis, or both the x and y axis.

In some implementations consecutive applications of the first pulse sequence to the qubit implements a

$${[ X , - X ]}^{\frac{N}{2}}$$

gate sequence, where X represents a Pauli-X gate and N represents gate depth; and consecutive applications of the second pulse sequence to the qubit implements a

$${[ X , Y , X , Y ]}^{\frac{N}{4}}$$

gate sequence, where X represents a Pauli-X gate, Y represents a Pauli-Y gate, and N represents gate depth.

In some implementations inverting the transfer function at the determined values of the parameters of the reflection model comprises inverting the transfer function in the Fourier domain.

In some implementations pre-distorting a control pulse for the qubit comprises multiplying the inverted transfer function in the Fourier domain by a Fourier transform of the control pulse; and applying an inverse Fourier transform to obtain a pre-distorted control pulse in the time domain.

In general, another innovative aspect of the subject matter described in this specification can be implemented in a method performed by a quantum computing device, the method comprising: generating a pre-distorted control signal that implements a single qubit rotation operation; and applying the pre-distorted control signal to a qubit to perform the rotation operation on the qubit, the pre-distorted control signal comprising an inverted transfer function, wherein: the inverted transfer function comprises values of parameters obtained through fitting measured qubit parasitic rotation angles per gate to a reflection model that models pulse distortion in the quantum computing device; and the qubit parasitic rotation angles per gate are measured using a first pulse sequence that amplifies out-of-phase pulse distortion in the quantum computing device and a second pulse sequence that amplifies in-phase pulse distortion in the quantum computing device.

Other implementations of these aspects include corresponding computer systems, apparatus, and computer programs recorded on one or more computer storage devices, each configured to perform the actions of the methods. A system of one or more classical and quantum computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations the second pulse sequence comprises: a π pulse about an x axis, followed by a π pulse about the y axis, followed by a π pulse about an x axis, followed by a π pulse about the y axis.

In some implementations parameters of the reflection model comprise reflection amplitude, round-trip reflection time, and phase shift imparted by reflection.

In some implementations the reflection model comprises a combination of an ideal control signal and a reflection component that comprises delayed control signals, wherein the delayed control signals are dependent on a round-trip reflection time parameter and are weighted by respective reflection amplitudes and reflection phase shifts.

The subject matter described in this specification can be implemented in particular ways so as to realize one or more of the following advantages.

Examples of the presently described control pulse distortion compensation procedure can reduce control error and improve quantum gate fidelity in quantum computing systems. For example, it has been shown that in some superconducting qubit systems, for short inter-pulse delays, e.g., delays less than 10 ns, the parasitic rotation angle per gate is appreciably closer to zero when the presently described reflection compensation procedure is applied.

Further, examples of the presently described control pulse distortion compensation procedure can improve on known methods in several ways. For example, some known methods recover distortion out-of-phase with the driving signal, but do not address distortion occurring in-phase with the drive. However, the presently described techniques can recover both distortion occurring in-phase with the drive and out-of-phase with the drive. As another example, some known methods assume that control pulses have a short duration so that the drive pulse itself can be approximated as being distortion free. This limits the applicability of such methods.

However, the presently described techniques do not require the same assumptions and do not make such approximations and are therefore applicable to a wider range of quantum computing devices, e.g., those where the control pulses have a longer duration.

Details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example system for microwave pulse distortion compensation.

FIG. 2 is a flow diagram of an example process for generating a pre-distorted control pulse that reduces out-of-phase and in-phase pulse distortion.

FIG. 3 is a flow diagram of an example process for performing a quantum computation using pre-distorted control pulses.

FIG. 4 shows several plots that illustrate results of an example reflection model analysis and compensation procedure.

FIG. 5 depicts an example quantum computing device.

### DETAILED DESCRIPTION

The ability to precisely control the state of a collection of quantum bits is a fundamental requirement of a quantum computer. In many superconducting quantum processor implementations, coherent transformation of the qubit state i.e., logic gates, are enacted by applying pulsed microwave electromagnetic control signals to the qubits. Slight deviations from the intended pulse shape result in imperfect state transformation which is referred to as control error. Microwave pulse distortion is an important source of control error in superconducting qubit systems. Further, reflections arising from impedance discontinuities in the signal chain are a common cause of pulse distortion.

This specification describes techniques for characterizing and/or compensating pulse distortion in a quantum computing system. Pulse sequences that amplify both in-phase and out-of-phase distortion are used to determined reflection model parameters, which are then used to pre-distort single qubit control pulses such that single qubit gates performed using the pre-distorted control pulses experience less control error and achieve improved gate fidelity.

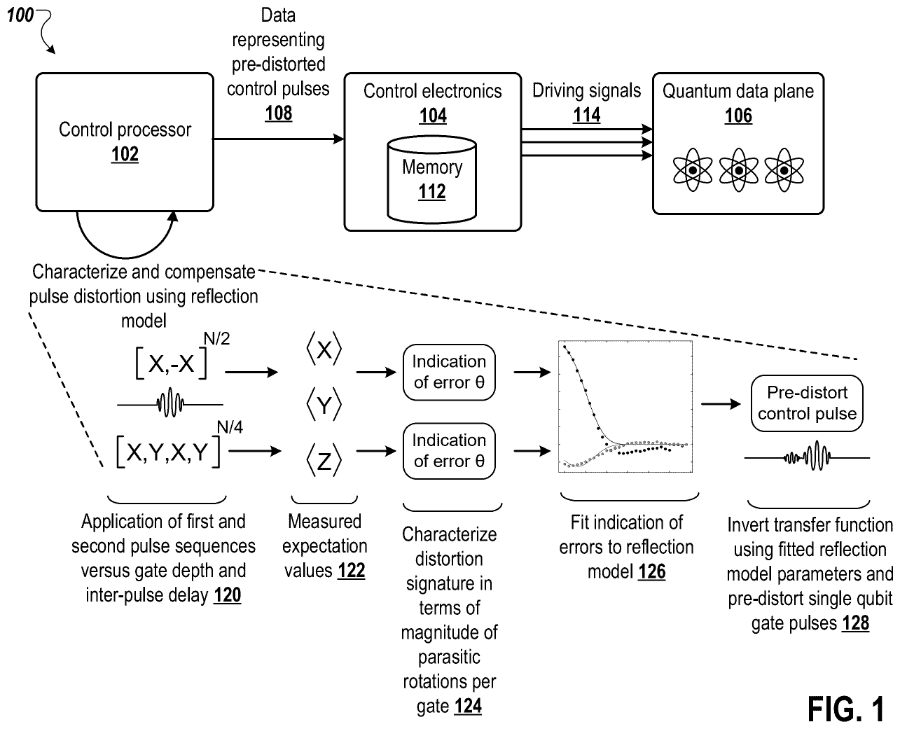

FIG. 1 depicts an example system 100 for microwave pulse distortion compensation. The example system 100 is an example of a system implemented as part of a quantum computing device in which the systems, components and techniques described in this specification can be implemented.

The system 100 includes a control processor 102, control electronics 104, and a quantum data plane 106. In some implementations, some, or all of the components of the example system 100 can be directly connected. In other implementations, some, or all of the components of the example system 100 can be connected through a network, e.g., a local area network (LAN), wide area network (WAN), the Internet, or a combination thereof.

The control processor 102 is a classical processor that can be implemented as one or more computer programs, i.e., one or more modules of computer program instructions encoded on a tangible non-transitory storage medium for execution by, or to control the operation of, a data processing apparatus. The computer storage medium can be a machine-readable storage device, a machine-readable storage substrate, a random or serial access memory device, one or more qubits, or a combination of one or more of them.

The control processor 102 is configured to perform operations that characterize and compensate pulse distortion in the system 100. For example, to characterize the pulse distortion the control processor 102 is configured to measure expectation values 122 of Pauli operators X, Y, and Z after a first pulse sequence (corresponding to gate sequence [X,−X]^{N/2}) and a second pulse sequence (corresponding to gate sequence

$${[ X , Y , X , Y ]}^{\frac{N}{4}} )$$

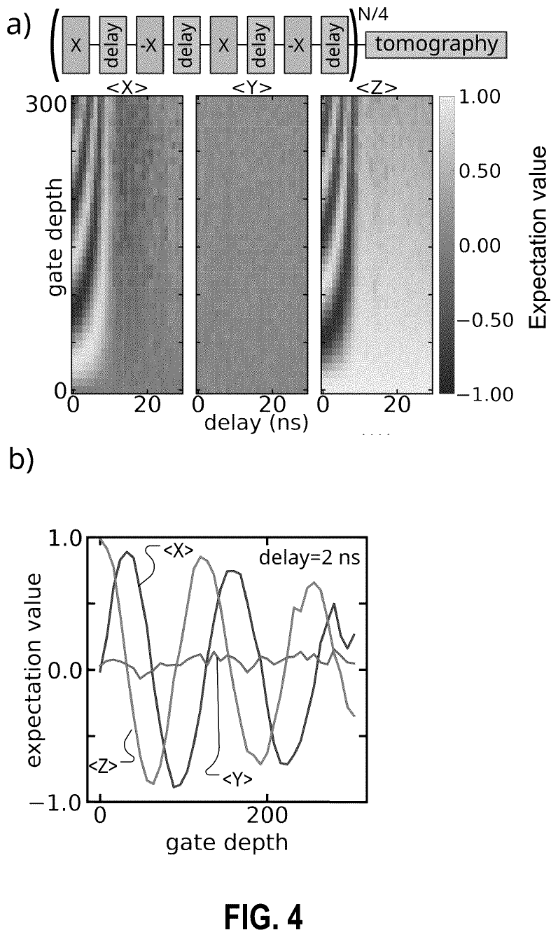

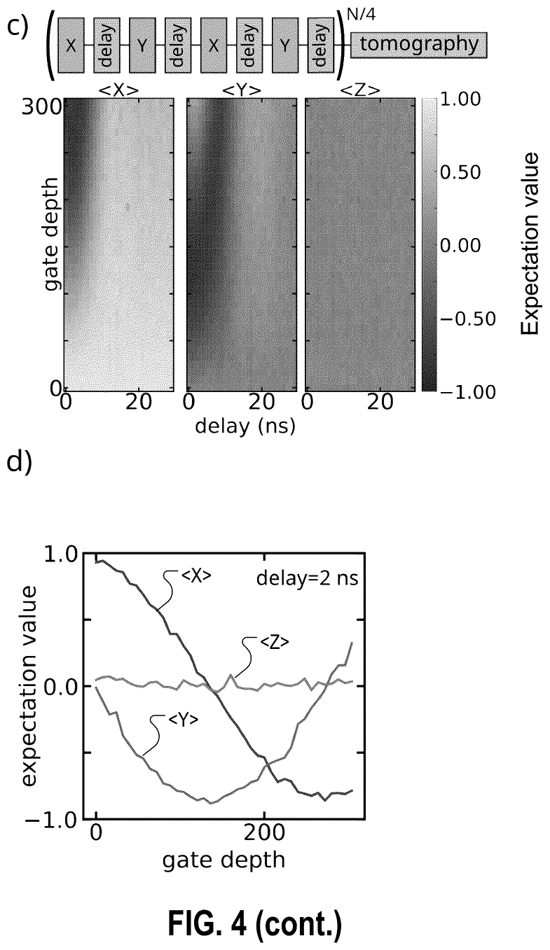

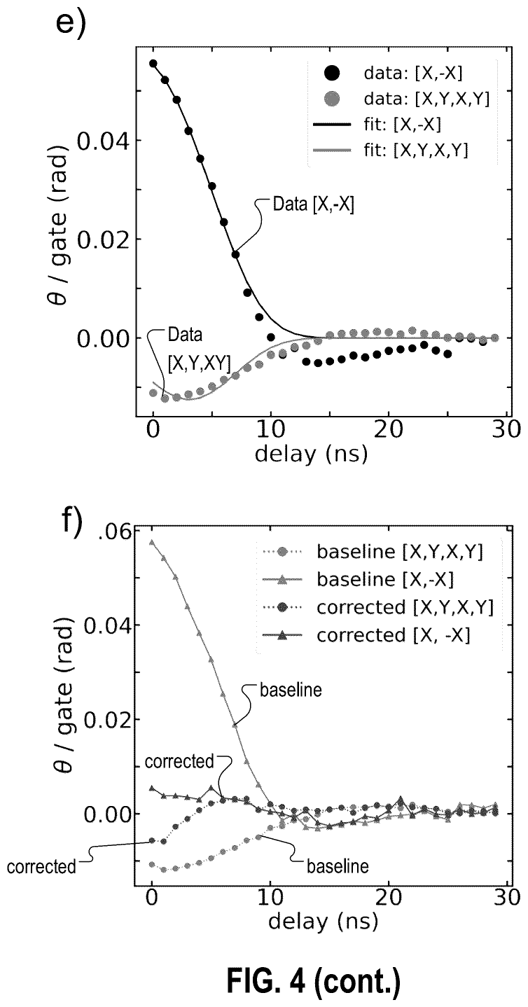

are applied to a qubit for a range of values of the gate depth N and the inter-pulse delay 120. The first pulse sequence is used to amplify distortion out-of-phase with the driving signal used to apply the pulse. The second pulse sequence is used to amplify distortion in-phase with the driving signal. Example output data obtained at these steps of the characterization procedure is shown and described in more detail below with reference to plots a)-d) of FIG. 4.

The control processor 102 is then configured to use the measured expectation values 122 to characterize the pulse distortion signature in terms of the magnitude of the parasitic rotation angle θ per gate 124, where the magnitude of the parasitic rotation θ provides an indication of control error in the system.

In contrast to conventional techniques for pulse distortion compensation, it is not assumed that the period during the control pulses is distortion free and the transfer function is not inferred via an unconstrained, model-free matrix inversion. Instead, it is assumed that the pulse distortion is dominated by a proper subset of reflections present in the system, e.g., a small number of reflections such as three reflections. The control processor 102 therefore fits the extracted magnitude of the parasitic rotation θ per gate to a reflection model 126, e.g., the reflection model given below

$$X ( t ) \to X ( t ) + {\sum }_{k = 1}^{∞} {a}_{reflect}^{k} {e}^{i k {ϕ}_{reflect}} X ( t - k {t}_{reflect} ) \qquad ( 1 )$$

where t represents time, X(t) represents an ideal driving signal, a_{reflect} represents a reflection amplitude, and ϕ_{reflect} represents a phase shift imparted by reflection.

The control processor is configured to numerically optimize the reflection model parameters a_{reflect}, ϕ_{reflect}, and t_{reflect} by comparing the measured magnitude of the parasitic rotation θ per gate to a predicted pulse distortion generated by the reflection model. To mitigate the reflections, the control processor 102 is configured to invert a transfer function that describes the pulse distortion at values of the optimized reflection model parameters a_{reflect}, ϕ_{reflect}, and t_{reflect}, and pre-distort single qubit gate control pulses using the inverted transfer function 128.

The control processor 102 is configured to provide data representing the pre-distorted control pulses 108 to the control electronics 104. The control electronics 104 is configured to convert data received from the control processor 102, e.g., digital signals representing pre-distorted control pulses, to analog driving signals 114 (also referred to herein as control signals) required to perform corresponding single qubit gates on qubits included in the quantum data plane 106. For example, the control electronics 104 can include control devices that operate physical qubits included in the quantum data plane 106. Example control devices include arbitrary waveform generators or control devices that tune frequencies of respective qubits by applying driving signals, e.g., voltage pulses, to the qubits through respective control lines. In some implementations the control electronics 104 can include a memory 112 that is configured to store data, e.g., data specifying pre-defined pre-distorted control pulses generated by the control processor 102.

The quantum data plane 106 includes physical qubits for performing quantum computations. The type of qubits that the quantum data plane 106 utilizes is dependent on the types of computations being performed by the system 100. For example, in some cases the quantum data plane 106 can include one or more resonators attached to one or more superconducting qubits, e.g., Gmon or Xmon qubits. In other cases, the quantum data plane 106 can include ion traps, photonic devices or superconducting cavities. Further examples of realizations of qubits include fluxmon qubits, silicon quantum dots or phosphorus impurity qubits. In some cases, the qubits may be a part of a quantum circuit.

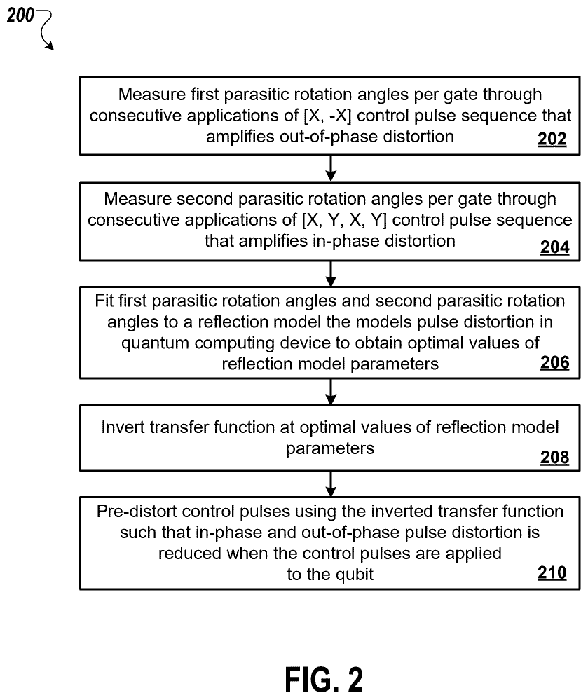

Example operations performed by components of the system 100 are described in more detail below with reference to FIGS. 2-4.

FIG. 2 is a flow diagram of an example process 200 for generating a pre-distorted control pulse that reduces out-of-phase and in-phase pulse distortion. For convenience, the process 200 will be described as being performed by a quantum computing system. For example, the system 100 of FIG. 1, appropriately programmed in accordance with this specification, can perform the process 200.

The system measures first parasitic rotation angles per gate through respective consecutive applications of a first pulse sequence to the qubit (step 202). The first pulse sequence amplifies out-of-phase pulse distortion in the quantum computing device and includes a π pulse about an x axis followed by a −π pulse about the x axis. That is, the first pulse sequence implements a [X,−X] gate sequence and consecutive applications of the first pulse implement a

$${[ X , - X ]}^{\frac{N}{2}}$$

gate sequence, where X represents a Pauli-X gate and N represents gate depth.

To measure the first qubit parasitic rotation angles per gate, the system applies the first pulse sequence to the qubit (and subsequently measures the qubit) at each of multiple different gate depths and each of multiple different inter-pulse delays. In some implementations the qubit can be initialized in the zero state before each application of the

$${[ X , - X ]}^{\frac{N}{2}}$$

gate sequence.

The specific number of different gate depths and range of gate depths used depends on the specific technical implementation and can vary. Similarly, the number of different inter-pulse delays and range of inter-pulse delays used depends on the specific technical implementation and can vary. For example, the maximum gate depth and maximum inter-pulse delay can be set based on a mean gate error and measure error for the device. In some implementations the multiple different gate depths can include gate depths from the range N=[0, 300] and the multiple different inter-pulse delays can include delays from the range [0, 30 ns].

The system then computes expectation values of one or more Pauli operators, e.g., Pauli X, Y, and Z operators, using measurement results obtained from the consecutive applications of the first pulse sequence to the qubit. The first parasitic rotation angles per gate are extracted for each inter-pulse delay in a subset of the multiple different inter-pulse delays from the measurement results, e.g., from the expectation values of the Pauli operators. For example, the system can extract a first parasitic rotation angle θ for a specific fixed inter-pulse delay by computing the ratio of the expectation values [symbol] X [symbol] and [symbol] Z [symbol] and then computing the arctan of the ratio. The system can repeat this process at multiples of gate depth. The extracted first parasitic rotation angle θ increases linearly with the gate depth. The system divides the first parasitic rotation angle θ by the gate depth to obtain the first parasitic rotation angle θ per gate (at the fixed inter-pulse delay). That is, the system computes θ per gate=arctan ( [symbol] X [symbol] / [symbol] Z [symbol] )/gate depth.

The system measures second parasitic rotation angles per gate through respective consecutive applications of a second pulse sequence to the qubit (step 204). The second pulse sequence amplifies in-phase pulse distortion in the quantum computing device and includes a π pulse about an x axis, followed by a π pulse about the y axis, followed by a π pulse about an x axis, followed by a π pulse about the y axis. That is, the second pulse sequence implements a [X, Y, X, Y] gate sequence and consecutive applications of the first pulse implement a

$${[ X , Y , X , Y ]}^{\frac{N}{4}}$$

gate sequence, where X represents a Pauli-X gate, Y represents a Pauli-Y gate, and N represents gate depth.

To measure the second parasitic rotation angles per gate, the system applies the second pulse sequence to the qubit (and subsequently measures the qubit) at each of the multiple different gate depths and each of the multiple different inter-pulse delays, e.g., the same range of gate depths and inter-pulse delays used to measure the first parasitic rotation angle per gate as described above with reference to step (202). In some implementations the qubit can be initialized in a plus state (|0 [symbol] +|1 [symbol] )/√2 before each application of the

$${[ X , Y , X , Y ]}^{\frac{N}{4}}$$

gate sequence.

The second parasitic rotation angles per gate are also extracted for each inter-pulse delay in a subset of the multiple different inter-pulse delays from the measurement results, e.g., the same subset as described above with reference to step 202. The system can extract a second parasitic rotation angle θ for a specific fixed inter-pulse delay by computing the ratio of the expectation values [symbol] Y [symbol] and [symbol] X [symbol] and then computing the arctan of the ratio. The system can repeat this process at multiples of gate depth. The extracted second parasitic rotation angle θ increases linearly with the gate depth. The system divides the second parasitic rotation angle θ by the gate depth to obtain the second parasitic rotation angle θ per gate (at the specific fixed inter-pulse delay). That is, the system computes θ per gate=arctan ( [symbol] Y [symbol] / [symbol] X [symbol] )/gate depth.

The system then computes expectation values of one or more Pauli operators, e.g., Pauli X, Y, and Z operators, using measurement results obtained from the consecutive applications of the second pulse sequence to the qubit. The second parasitic rotation angle per gate can be extracted from the measurement results, e.g., from the expectation values of the Pauli operators.

The system fits the first parasitic rotation angle per gate and the second parasitic rotation angle per gate to a reflection model that models pulse distortion in the quantum computing device (step 206). The reflection model is parameterized by reflection model parameters that include reflection amplitude, round-trip reflection time, and phase shift imparted by reflection, and is a combination of an ideal control signal and a reflection component. The reflection component includes delayed control signals, wherein the delayed control signals are dependent on a round-trip reflection time parameter and are weighted by respective reflection amplitudes and reflection phase shifts. That is, in some examples the reflection model can be given by Eq. (1), which for convenience is repeated below:

$$X ( t ) \to X ( t ) + {\sum }_{k = 1}^{∞} {a}_{reflect}^{k} {e}^{i k {ϕ}_{reflect}} X ( t - k {t}_{reflect} ) ,$$

where t represents time, X(t) represents an ideal control signal, a_{reflect} represents a reflection amplitude, and ϕ_{reflect} represents a phase shift imparted by reflection.

To fit the first parasitic rotation angle per gate and the second parasitic rotation angle per gate to the reflection model, the system numerically optimizes the reflection model parameters using the first qubit parasitic rotation angle per gate and the second qubit parasitic rotation angle per gate to determine optimal values of the reflection model parameters.

The system inverts a transfer function at the optimal values of the reflection model parameters (step 208). The transfer function represents the impulse response of the signal transmitting channel, for example, a wiring chain that transmits the driving signals (114 in FIG. 1) from control electronics (104 in FIG. 1) to the qubit in the quantum data plane (106 in FIG. 1) and corresponds to the reflection component of the reflection model. An example frequency-domain transfer function H(f) that corresponds to Eq. (1) can be given by:

$$H ( f ) = \frac{1}{1 - {a}_{reflect} exp ( i {ϕ}_{reflect} - i 2 π {ft}_{reflect} )}$$

where a_{reflect}, ϕ_{reflect}, and t_{reflect} are the reflection model parameters defined above and exp represents an exponential.

To pre-distort the control pulse, the inverse of the above transfer function is multiplied by the Fourier transform of the control pulse, and an inverse Fourier transform is applied to the multiplied inverted transfer function and control pulse to obtain the pre-distorted control pulse in the time domain.

The system pre-distorts one or more control pulses for the qubit using the inverted transfer function such that, when applied to the qubit, out-of-phase and in-phase pulse distortion is reduced (step 210). For example, for a given control pulse, the system can apply a Fourier transform to the control pulse in the time domain and multiply the inverted transfer function in the Fourier domain by the control pulse in the Fourier domain. The system can then apply an inverse Fourier transform to the multiplied inverted transfer function and control pulse to obtain a pre-distorted control pulse in the time domain. The control pulses can include control pulses that implement qubit state rotations about the x axis, y axis, or both the x and y axis.

In some implementations the system can cause application of the pre-distorted control pulses to the qubit (i.e., without storing the pre-distorted one or more control pulses). Alternatively, the system can store the pre-distorted one or more control pulses, e.g., in control electronics memory. For example, the system can perform steps 202-210 described above in advance so that when the system subsequently performs a quantum computation, the control pulses need not be distorted on-the-fly but retrieved from memory and applied to one or more qubits. In some implementations the system can perform steps 202-210 described above each time operating frequencies of a qubit are adjusted, e.g., calibrated to updated values.

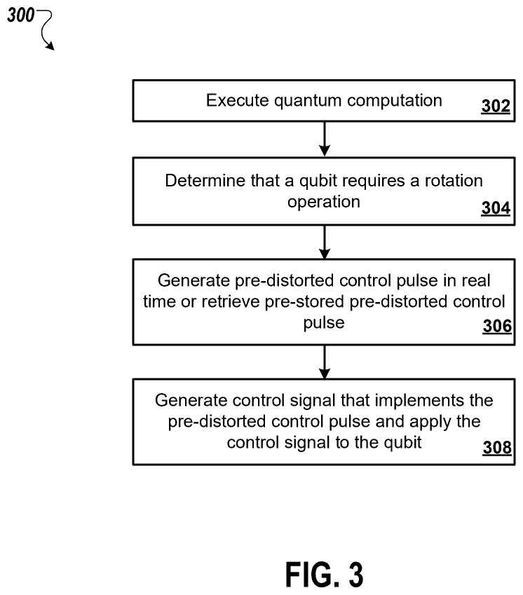

FIG. 3 is a flow diagram of an example process 300 for performing a quantum computation using pre-distorted control pulses. For convenience, the process 300 will be described as being performed by a quantum computing system. For example, the system 100 of FIG. 1, appropriately programmed in accordance with this specification, can perform the process 300.

The quantum computing device executes a quantum computation (step 302). During execution of the quantum computation, the system can determine that a qubit requires a rotation operation, e.g., a rotation about the x and/or y axis (step 304). In response to determining that the qubit requires the rotation operation, the system can either generate a corresponding pre-distorted control pulse in real time (as described above with reference to FIG. 2) or retrieve a pre-stored pre-distorted control pulse (where the pre-distorted control pulse was generated using some or all of the techniques described above with reference to FIG. 2) (step 306). The system can then generate a control signal that implements the pre-distorted control pulse and apply the control signal to the qubit (step 308).

FIG. 4 shows several plots that illustrate results of an example reflection model analysis and compensation procedure. Plot a) shows observed expectation values for a [X,−X]^{N/2} pulse sequence versus gate depth and inter-pulse delay for a qubit initialized to the zero state |0 [symbol] . The x-axis of the plot represents inter-pulse delay and ranges from zero to 30 ns. The y-axis of the plot represents gate depth and ranges from zero to 300. The plot includes observed expectation values [symbol] X [symbol] , [symbol] Y [symbol] , and [symbol] Z [symbol] for Pauli operators X, Y, and Z, respectively.

Plot b) shows the gate depth dependence at a fixed inter-pulse delay of 2 ns from the data in plot a). The x-axis of the plot represents the gate depth and y-axis of the plot represents the expectation value of the Pauli operators X, Y, and Z. The plot shows that the state of the qubit experiences a parasitic rotation about the y-axis of the Bloch sphere, which results from distortion out-of-phase with the driving signal that is amplified by the [X,−X]^{N/2} pulse sequence. From the data shown in plot b) a first parasitic rotation angle θ of approximately 0.05 radians is obtained. Plots a) and b) correspond to step 202 of example process 200 described above with reference to FIG. 2.

Plots c) and d) are analogous plots to a) and b) for a

$${[ X , Y , X , Y ]}^{\frac{N}{4}}$$

pulse sequence versus gate depth and inter-pulse delay for a qubit initialized to the plus state (|0 [symbol] +|1 [symbol] )/√2. In this case, errors from distortion in-phase with the driving signal are amplified and the plot shows that the state of the qubit experiences a parasitic rotation about the z axis of the Bloch sphere. Plots c) and d) correspond to step 204 of example process 200 described above with reference to FIG. 2. From the data shown in plot d) a first parasitic rotation angle θ of approximately 0.01 radians is obtained.

Plot e) shows the extracted parasitic rotation angle per gate for the subset of inter-pulse delays (represented by the solid circles) and reflection model fits for both the [X,−X]^{N/2} and

$${[ X , Y , X , Y ]}^{\frac{N}{4}}$$

pulse sequences. Plot e) corresponds to step 206 of example process 200 described above with reference to FIG. 2.

Plot f) shows results of applying the presently described pre-distorted control pulses, e.g., after steps 208 and 210 of example process 200 described above with reference to FIG. 2 have been performed using the parameters determined through the reflection model fits shown in plot e) and the pre-distorted control pulse has been applied to the qubit. In particular, plot f) compares the parasitic rotation angle per gate experienced by the qubit both with and without reflection model pulse compensation. As shown, for short inter-pulse delays the parasitic rotation angle is appreciably closer to zero when reflection compensation is applied.

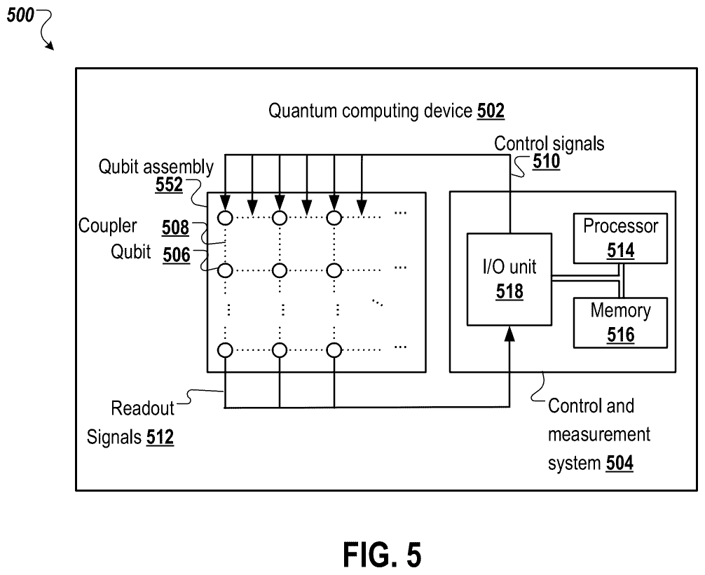

FIG. 5 depicts an example quantum computer 500 for performing the quantum operations described in this specification. The example quantum computer 500 includes an example quantum computing device 502. The quantum computing device 502 is intended to represent various forms of quantum computing devices. The components shown here, their connections and relationships, and their functions, are exemplary only, and do not limit implementations of the inventions described and/or claimed in this document.

The example quantum computing device 502 includes a qubit assembly 552 and a control and measurement system 504. The qubit assembly includes multiple qubits, e.g., qubit 506, that are used to perform algorithmic operations or quantum computations. While the qubits shown in FIG. 5 are arranged in a rectangular array, this is a schematic depiction and is not intended to be limiting. For example, qubits may be configured in alternative arrays or according to different geometries entirely. The qubit assembly 552 also includes adjustable coupling elements, e.g., coupler 508, that allow for interactions between coupled qubits. In the schematic depiction of FIG. 5, each qubit is adjustably coupled to each of its four adjacent qubits by means of respective coupling elements. However, this is an example arrangement of qubits and couplers, and other arrangements are possible, including arrangements that are non-rectangular, arrangements that allow for fixed coupling between some or all qubits, coupling between non-adjacent qubits, and/or arrangements that include (optionally adjustable) coupling between more than two qubits.

Each qubit can be a physical two-level quantum system or device having levels representing logical values of 0 and 1. The specific physical realization of the multiple qubits and how they interact with one another is dependent on a variety of factors including the type of the quantum computing device 502 included in the example computer 500 or the type of quantum computations that the quantum computing device is performing. For example, in an atomic quantum computer the qubits may be realized via atomic, molecular, or solid-state quantum systems, e.g., hyperfine atomic states. As another example, in a superconducting quantum computer the qubits may be realized via superconducting qubits, e.g., superconducting transmon qubits. As another example, in a NMR quantum computer the qubits may be realized via nuclear spin states.

In some implementations a quantum computation can proceed by loading qubits, e.g., from a quantum memory, and applying a sequence of unitary operators to the qubits. Applying a unitary operator to the qubits can include applying a corresponding sequence of quantum logic gates to the qubits, e.g., to implement the gate sequences described in this specification. Example quantum logic gates include single-qubit gates, e.g., Pauli-X, Pauli-Y, Pauli-Z (also referred to as X, Y, Z), Hadamard gates, S gates, rotations, two-qubit gates, e.g., controlled-X, controlled-Y, controlled-Z (also referred to as CX, CY, CZ), controlled NOT gates (also referred to as CNOT) controlled swap gates (also referred to as CSWAP), iSWAP gates, and gates involving three or more qubits, e.g., Toffoli gates. The quantum logic gates can be implemented by applying control signals 510 generated by the control and measurement system 504 to the qubits and to the couplers, where the control signals implement corresponding control pulse/gate sequences.

For example, in some implementations the qubits in the qubit assembly 552 can be frequency tunable. In these examples, each qubit can have associated operating frequencies that can be adjusted through application of voltage pulses via one or more drive-lines coupled to the qubit. Example operating frequencies include qubit idling frequencies, qubit interaction frequencies, and qubit readout frequencies. Different frequencies correspond to different operations that the qubit can perform. For example, setting the operating frequency to a corresponding idling frequency may put the qubit into a state where it does not strongly interact with other qubits, and where it may be used to perform single-qubit gates. As another example, in cases where qubits interact via couplers with fixed coupling, qubits can be configured to interact with one another by setting their respective operating frequencies at some gate-dependent frequency detuning from their common interaction frequency. In other cases, e.g., when the qubits interact via tunable couplers, qubits can be configured to interact with one another by setting the parameters of their respective couplers to enable interactions between the qubits and then by setting the qubit's respective operating frequencies at some gate-dependent frequency detuning from their common interaction frequency. Such interactions may be performed in order to perform multi-qubit gates.

The type of control signals 510 used depends on the physical realizations of the qubits. For example, the control signals may include RF or microwave pulses in an NMR or superconducting quantum computer system, or optical pulses in an atomic quantum computer system.

A quantum computation can be completed by measuring the states of the qubits, e.g., using a quantum observable such as X or Z, using respective control signals 510. The measurements cause readout signals 512 representing measurement results to be communicated back to the measurement and control system 504. The readout signals 512 may include RF, microwave, or optical signals depending on the physical scheme for the quantum computing device and/or the qubits. For convenience, the control signals 510 and readout signals 512 shown in FIG. 5 are depicted as addressing only selected elements of the qubit assembly (i.e., the top and bottom rows), but during operation the control signals 510 and readout signals 512 can address each element in the qubit assembly 552.

The control and measurement system 504 is an example of a classical computer system that can be used to perform various operations on the qubit assembly 552, as described above, as well as other classical subroutines or computations described herein. The control and measurement system 504 includes one or more classical processors, e.g., classical processor 514, one or more memories, e.g., memory 516, and one or more I/O units, e.g., I/O unit 518, connected by one or more data buses. The control and measurement system 504 can be programmed to send sequences of control signals 510 to the qubit assembly, e.g. to carry out a selected series of quantum gate operations, and to receive sequences of readout signals 512 from the qubit assembly, e.g. as part of performing measurement operations.

The processor 514 is configured to process instructions for execution within the control and measurement system 504. In some implementations, the processor 514 is a single-threaded processor. In other implementations, the processor 514 is a multi-threaded processor. The processor 514 is capable of processing instructions stored in the memory 516.

The memory 516 stores information within the control and measurement system 504, e.g., data specifying pre-distorted control pulses. In some implementations, the memory 516 includes a computer-readable medium, a volatile memory unit, and/or a non-volatile memory unit. In some cases, the memory 516 can include storage devices capable of providing mass storage for the system 504, e.g., a hard disk device, an optical disk device, a storage device that is shared over a network by multiple computing devices (e.g., a cloud storage device), and/or some other large capacity storage device.

The input/output device 518 provides input/output operations for the control and measurement system 504. The input/output device 518 can include D/A converters, A/D converters, and RF/microwave/optical signal generators, transmitters, and receivers, whereby to send control signals 510 to and receive readout signals 512 from the qubit assembly, as appropriate for the physical scheme for the quantum computer. In some implementations, the input/output device 518 can also include one or more network interface devices, e.g., an Ethernet card, a serial communication device, e.g., an RS-232 port, and/or a wireless interface device, e.g., an 802.11 card. In some implementations, the input/output device 518 can include driver devices configured to receive input data and send output data to other external devices, e.g., keyboard, printer and display devices.

Although an example control and measurement system 504 has been depicted in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and operations described in this specification can be implemented in digital electronic circuitry, analog electronic circuitry, suitable quantum circuitry or, more generally, quantum computational systems, in tangibly-embodied software or firmware, in computer hardware, including the structures disclosed in this specification and their structural equivalents, or in combinations of one or more of them. The term “quantum computational systems” may include, but is not limited to, quantum computers, quantum information processing systems, quantum cryptography systems, or quantum simulators.

Implementations of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, one or more qubits, or a combination of one or more of them. Alternatively, or in addition, the program instructions can be encoded on an artificially-generated propagated signal that is capable of encoding digital and/or quantum information, e.g., a machine-generated electrical, optical, or electromagnetic signal, that is generated to encode digital and/or quantum information for transmission to suitable receiver apparatus for execution by a data processing apparatus.

The terms quantum information and quantum data refer to information or data that is carried by, held or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, multiple digital and quantum processors or computers, and combinations thereof. The apparatus can also be, or further include, special purpose logic circuitry, e.g., an FPGA (field programmable gate array), an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL or Quipper.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable computers, operating with one or more processors, as appropriate, executing one or more computer programs to perform functions by operating on input data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more computers to be “configured to” perform particular operations or actions means that the system has installed on its software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For example, a quantum computer may receive instructions from a digital computer that, when executed by the quantum computing apparatus, cause the apparatus to perform the operations or actions.

Computers suitable for the execution of a computer program can be based on general or special purpose processors, or any other kind of central processing unit. Generally, a central processing unit will receive instructions and data from a read-only memory, a random access memory, or quantum systems suitable for transmitting quantum data, e.g., photons, or combinations thereof.

The elements of a computer include a central processing unit for performing or executing instructions and one or more memory devices for storing instructions and digital, analog, and/or quantum data. The central processing unit and the memory can be supplemented by, or incorporated in, special purpose logic circuitry or quantum simulators. Generally, a computer will also include, or be operatively coupled to receive data from or transfer data to, or both, one or more mass storage devices for storing data, e.g., magnetic, magneto-optical disks, optical disks, or quantum systems suitable for storing quantum information. However, a computer need not have such devices.

Quantum circuit elements (also referred to as quantum computing circuit elements) include circuit elements for performing quantum processing operations. That is, the quantum circuit elements are configured to make use of quantum-mechanical phenomena, such as superposition and entanglement, to perform operations on data in a non-deterministic manner. Certain quantum circuit elements, such as qubits, can be configured to represent and operate on information in more than one state simultaneously. Examples of superconducting quantum circuit elements include circuit elements such as quantum LC oscillators, qubits (e.g., flux qubits, phase qubits, or charge qubits), and superconducting quantum interference devices (SQUIDs) (e.g., RF-SQUID or DC-SQUID), among others.

In contrast, classical circuit elements generally process data in a deterministic manner. Classical circuit elements can be configured to collectively carry out instructions of a computer program by performing basic arithmetical, logical, and/or input/output operations on data, in which the data is represented in analog or digital form. In some implementations, classical circuit elements can be used to transmit data to and/or receive data from the quantum circuit elements through electrical or electromagnetic connections. Examples of classical circuit elements include circuit elements based on CMOS circuitry, rapid single flux quantum (RSFQ) devices, reciprocal quantum logic (RQL) devices and ERSFQ devices, which are an energy-efficient version of RSFQ that does not use bias resistors.

In certain cases, some or all of the quantum and/or classical circuit elements may be implemented using, e.g., superconducting quantum and/or classical circuit elements. Fabrication of the superconducting circuit elements can entail the deposition of one or more materials, such as superconductors, dielectrics and/or metals. Depending on the selected material, these materials can be deposited using deposition processes such as chemical vapor deposition, physical vapor deposition (e.g., evaporation or sputtering), or epitaxial techniques, among other deposition processes. Processes for fabricating circuit elements described herein can entail the removal of one or more materials from a device during fabrication. Depending on the material to be removed, the removal process can include, e.g., wet etching techniques, dry etching techniques, or lift-off processes. The materials forming the circuit elements described herein can be patterned using known lithographic techniques (e.g., photolithography or e-beam lithography).

During operation of a quantum computational system that uses superconducting quantum circuit elements and/or superconducting classical circuit elements, such as the circuit elements described herein, the superconducting circuit elements are cooled down within a cryostat to temperatures that allow a superconductor material to exhibit superconducting properties. A superconductor (alternatively superconducting) material can be understood as material that exhibits superconducting properties at or below a superconducting critical temperature. Examples of superconducting material include aluminum (superconductive critical temperature of 1.2 kelvin) and niobium (superconducting critical temperature of 9.3 kelvin). Accordingly, superconducting structures, such as superconducting traces and superconducting ground planes, are formed from material that exhibits superconducting properties at or below a superconducting critical temperature.

In certain implementations, control signals for the quantum circuit elements (e.g., qubits and qubit couplers) may be provided using classical circuit elements that are electrically and/or electromagnetically coupled to the quantum circuit elements. The control signals may be provided in digital and/or analog form.

Computer-readable media suitable for storing computer program instructions and data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a computer program product that includes instructions that are stored on one or more non-transitory machine-readable storage media, and that are executable on one or more processing devices. The systems described in this specification, or portions of them, can each be implemented as an apparatus, method, or system that may include one or more processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by a quantum computing device, the method comprising:
measuring first qubit parasitic rotation angles per gate through consecutive applications of a first pulse sequence to the qubit, wherein the first pulse sequence comprises: a π pulse about an x axis followed by a −π pulse about the x axis and each first qubit parasitic rotation angle per gate corresponds to a respective inter-pulse delay;
measuring second qubit parasitic rotation angles per gate through consecutive applications of a second pulse sequence to the qubit, wherein the second pulse sequence comprises: a π pulse about the x axis, followed by a π pulse about the y axis, followed by a π pulse about the x axis, followed by a π pulse about the y axis and each first qubit parasitic rotation angle per gate corresponds to a respective inter-pulse delay;
determining values of parameters of a reflection model to fit the first qubit parasitic rotation angles per gate and the second qubit parasitic rotation angles per gate to the reflection model, wherein the reflection model models pulse distortion in the quantum computing device, comprising determining values of parameters of the reflection model;
inverting a transfer function at the determined values of the parameters of the reflection model, wherein the transfer function corresponds to the reflection model; and
pre-distorting one or more control pulses for the qubit using the inverted transfer function.

2. The method of claim 1, wherein the first pulse sequence amplifies out-of-phase pulse distortion in the quantum computing device and the second pulse sequence amplifies in-phase pulse distortion in the quantum computing device.

3. The method of claim 1, wherein pre-distorting the one or more control pulses for the qubit using the inverted transfer function comprises generating pre-distorted control pulses that, when applied to the qubit, reduce out-of-phase and in-phase pulse distortion.

4. The method of claim 1, wherein the parameters of the reflection model comprise reflection amplitude, round-trip reflection time, and phase shift imparted by reflection.

5. The method of claim 1, wherein the reflection model comprises a combination of an ideal control signal and a reflection component that comprises delayed control signals, wherein the delayed control signals are dependent on a round-trip reflection time parameter and are weighted by respective reflection amplitudes and reflection phase shifts.

6. The method of claim 1, wherein the reflection model X(t) is given by
$$X ( t ) \to X ( t ) + {\sum }_{k = 1}^{∞} {a}_{reflect}^{k} {e}^{i k {ϕ}_{reflect}} X ( t - k {t}_{reflect} )$$
where t represents time, X(t) represents an ideal control signal, a_{reflect} represents a reflection amplitude, and ϕ_{reflect} represents a phase shift imparted by reflection.

7. The method of claim 1, wherein determining values of parameters of the reflection model comprises numerically optimizing the values of parameters of the reflection model using the first qubit parasitic rotation angle per gate and the second qubit parasitic rotation angle per gate.

8. The method of claim 1, wherein:
measuring the first qubit parasitic rotation angles per gate through consecutive applications of the first pulse sequence to the qubit comprises applying the first pulse sequence to the qubit at each of multiple different gate depths and each of multiple different inter-pulse delays; and
measuring the second qubit parasitic rotation angles per gate through consecutive applications of the second pulse sequence to the qubit comprises applying the second pulse sequence to the qubit at each of the multiple different gate depths and each of the multiple different inter-pulse delays.

9. The method of claim 1, wherein:
measuring the first qubit parasitic rotation angles per gate comprises measuring expectation values of one or more Pauli operators following the consecutive applications of the first pulse sequence to the qubit; and
measuring the second qubit parasitic rotation angles per gate comprises measuring expectation values of the one or more Pauli operators following the consecutive applications of the second pulse sequence to the qubit.

10. The method of claim 1, further comprising applying the pre-distorted control pulses to the qubit during a quantum computation.

11. The method of claim 1, wherein the one or more control pulses comprise control pulses that implement rotations about the x axis, y axis, or both the x and y axis.

12. The method of claim 1, wherein:
consecutive applications of the first pulse sequence to the qubit implements a
$${[ X , - X ]}^{\frac{N}{2}}$$
gate sequence, where X represents a Pauli-X gate and N represents gate depth; and
consecutive applications of the second pulse sequence to the qubit implements a
$${[ X , Y , X , Y ]}^{\frac{N}{4}}$$
gate sequence, where X represents a Pauli-X gate, Y represents a Pauli-Y gate, and N represents gate depth.

13. The method of claim 1, wherein inverting the transfer function at the determined values of the parameters of the reflection model comprises inverting the transfer function in the Fourier domain.

14. The method of claim 13, wherein pre-distorting a control pulse for the qubit comprises:
multiplying the inverted transfer function in the Fourier domain by a Fourier transform of the control pulse; and
applying an inverse Fourier transform to obtain a pre-distorted control pulse in the time domain.

15. A quantum computing device comprising:
one or more qubits;
control electronics configured to apply control signals to the one or more qubits; and
a classical processor configured to process instructions for execution by the control electronics;
wherein the quantum computing device is configured to perform operations comprising:
measuring first qubit parasitic rotation angles per gate through consecutive applications of a first pulse sequence to the qubit, wherein the first pulse sequence comprises: a π pulse about an x axis followed by a −π pulse about the x axis and each first qubit parasitic rotation angle per gate corresponds to a respective inter-pulse delay;
measuring second qubit parasitic rotation angles per gate through consecutive applications of a second pulse sequence to the qubit, wherein the second pulse sequence comprises: a π pulse about the x axis, followed by a π pulse about the y axis, followed by a π pulse about the x axis, followed by a π pulse about the y axis and each first qubit parasitic rotation angle per gate corresponds to a respective inter-pulse delay;
determining values of parameters of a reflection model to fit the first qubit parasitic rotation angles per gate and the second qubit parasitic rotation angles per gate to the reflection model, wherein the reflection model models pulse distortion in the quantum computing device, comprising determining values of parameters of the reflection model;
inverting a transfer function at the determined values of the parameters of the reflection model, wherein the transfer function corresponds to the reflection model; and
pre-distorting one or more control pulses for the qubit using the inverted transfer function.

16. A method performed by a quantum computing device, the method comprising:
generating a pre-distorted control signal that implements a single qubit rotation operation; and
applying the pre-distorted control signal to a qubit to perform the rotation operation on the qubit, the pre-distorted control signal comprising an inverted transfer function, wherein:
the inverted transfer function comprises values of parameters obtained through fitting measured qubit parasitic rotation angles per gate to a reflection model that models pulse distortion in the quantum computing device; and
the qubit parasitic rotation angles per gate are measured using a first pulse sequence that amplifies out-of-phase pulse distortion in the quantum computing device and a second pulse sequence that amplifies in-phase pulse distortion in the quantum computing device.

17. The method of claim 16, wherein the second pulse sequence comprises: a π pulse about an x axis, followed by a π pulse about the y axis, followed by a π pulse about an x axis, followed by a π pulse about the y axis.

18. The method of claim 16, wherein parameters of the reflection model comprise reflection amplitude, round-trip reflection time, and phase shift imparted by reflection.

19. The method of claim 16, wherein the reflection model comprises a combination of an ideal control signal and a reflection component that comprises delayed control signals, wherein the delayed control signals are dependent on a round-trip reflection time parameter and are weighted by respective reflection amplitudes and reflection phase shifts.

20. A quantum computing device comprising:
one or more qubits;
control electronics configured to apply control signals to the one or more qubits; and
a classical processor configured to process instructions for execution by the control electronics;
wherein the quantum computing device is configured to perform operations comprising:
generating a pre-distorted control signal that implements a single qubit rotation operation; and
applying the pre-distorted control signal to a qubit to perform the rotation operation on the qubit, the pre-distorted control signal comprising an inverted transfer function, wherein:
the inverted transfer function comprises values of parameters obtained through fitting measured qubit parasitic rotation angles per gate to a reflection model that models pulse distortion in the quantum computing device; and
the qubit parasitic rotation angles per gate are measured using a first pulse sequence that amplifies out-of-phase pulse distortion in the quantum computing device and a second pulse sequence that amplifies in-phase pulse distortion in the quantum computing device.
